(19) United States
(12) Patent Application Publication
(10) Pub. No.: US 2024/0383262 A1
(43) Pub. Date: Nov. 21, 2024

(54) PRINTING APPARATUS, CONTROL METHOD, AND STORAGE MEDIUM

(71) Applicant: CANON KABUSHIKI KAISHA, Tokyo (JP)

(72) Inventor: KAZUYA KOIZUMI, Tokyo (JP)

(21) Appl. No.: 18/653,057

(22) Filed: May 2, 2024

(30) Foreign Application Priority Data
May 19, 2023 (JP) 2023-082827

(51) Int. Cl. B41J 2/21; B41J 2/045

(52) U.S. Cl. CPC B41J 2/2142; B41J 2/04541; B41J 2/04573; B41J 2/0458; B41J 2/04588; B41J 2/2135

(57) ABSTRACT

An embodiment of the present invention is a printing apparatus including a printhead, a conveyance unit that conveys a printing medium relative to the printhead at a predetermined speed, a storage unit that stores a correction value for changing timing of ink ejection in accordance with displacement between nozzle arrays, a switching unit that switches operation between print operation for printing an image and inspection operation for printing an image based on nozzle inspection data, without stopping conveyance operation performed by the conveyance unit, and a first generation unit that generates, based on the correction value, a signal for ejecting ink from the printhead. The first generation unit switches the correction value from valid to invalid in synchronization with switch from the print operation to the inspection operation performed by the switching unit.

### BACKGROUND

### Field

The present disclosure relates to a technique for inspecting the ejection state of nozzles provided in a printhead.

### Description of the Related Art

Conventionally, there are inkjet printing apparatuses that print an image on a printing medium by using thermal energy to eject ink droplets from one or more elongated printheads each having nozzles disposed over the width of the printing medium or longer (such a printhead is called a line head). As a technique applied to a printing apparatus of such a configuration, a technique has been proposed which inspects the ejection state of the ink ejection nozzles (hereinafter referred to simply as nozzles) provided in the printhead by utilizing ejection of ink droplets from the printhead.

Japanese Patent Laid-Open No. 2020-142503 discloses a method in which ejection condition parameters are changed in transmitting inspection data for inspection of the ejection state of nozzles. Also, Japanese Patent Laid-Open No. 2017-114049 discloses a technique for inspecting the ejection state of nozzles using the residual vibration of piezoelectric elements.

Incidentally, there is a case where during continuous printing, in which page images on a plurality of pages are continuously printed, an inspection image different from the page images is printed (the inspection image is, e.g., an image of an inspection pattern for detecting an discharge failure nozzle). In this case, restraint occurs such as having to stop ink ejection from other nozzle arrays while an inspection pattern for a certain nozzle array is printed by ink ejection. For this reason, inspection data considering the inter-array displacement (inter-array registration) of each nozzle array in the printhead needs to be prepared for each nozzle array and held in a memory.

### SUMMARY

However, inter-array registration may change after the fact and dynamically. In the patent literatures described above, in a case where the inter-array registration changes, inspection data considering the inter-array registration needs to be created anew and transferred to or loaded into the memory. Because such inspection data selects specified nozzles and causes ink to be ejected therefrom, data for each nozzle array needs to be loaded into the memory directly without hardware intervention. For this reason, the volume of the data is large. Thus, the specifications of the data transmission line in the printing apparatus need to be upgraded, which leads to higher costs.

An embodiment of the present invention is a printing apparatus having: a printhead having a plurality of nozzle arrays each of which is formed by a plurality of nozzles; a conveyance unit that conveys a printing medium relative to the printhead at a predetermined speed; a storage unit that stores a correction value for changing timing of ink ejection in accordance with displacement between the nozzle arrays; a switching unit that switches operation between print operation for printing an image and inspection operation for printing an image based on nozzle inspection data, without stopping conveyance operation performed by the conveyance unit; and a first generation unit that generates, based on the correction value, a signal for ejecting ink from the printhead, in which the first generation unit switches the correction value from valid to invalid in synchronization with switch from the print operation to the inspection operation performed by the switching unit.

Further features of the present invention will become apparent from the following description of exemplary embodiments with reference to the attached drawings.

### BRIEF DESCRIPTION OF THE DRAWINGS

FIG. 1 is a block diagram showing the hardware configuration of a printing apparatus;

FIG. 2 is a block diagram showing data flow in a print control unit;

FIGS. 3A and 3B are diagrams showing a schematic configuration of the printing apparatus;

FIG. 4 is a diagram showing the configuration of a printhead;

FIGS. 5A to 5C are diagrams showing a print region for actual printing and an inspection region for inspection of nozzle ejection state;

FIG. 6 is a block diagram of a control system of the printing apparatus;

FIG. 7 is a block diagram of a drive timing control unit according to a first embodiment;

FIG. 8 is a flowchart of inter-array registration reflection operation according to the first embodiment;

FIG. 9 is a timing chart for the drive timing control unit according to the first embodiment;

FIG. 10 is a diagram showing inspection timing according to the first embodiment;

FIG. 11 is a block diagram of a drive timing control unit according to a second embodiment;

FIG. 12 a timing chart for the drive timing control unit according to the second embodiment;

FIGS. 13A to 13C are diagrams illustrating challenges in the prior art; and

FIGS. 14A and 14B are diagrams illustrating challenges in the prior art.

### DESCRIPTION OF THE EMBODIMENTS

First, points that are common to a first embodiment and a second embodiment to be described later are described here together.

### <Configuration of the Printing Apparatus>

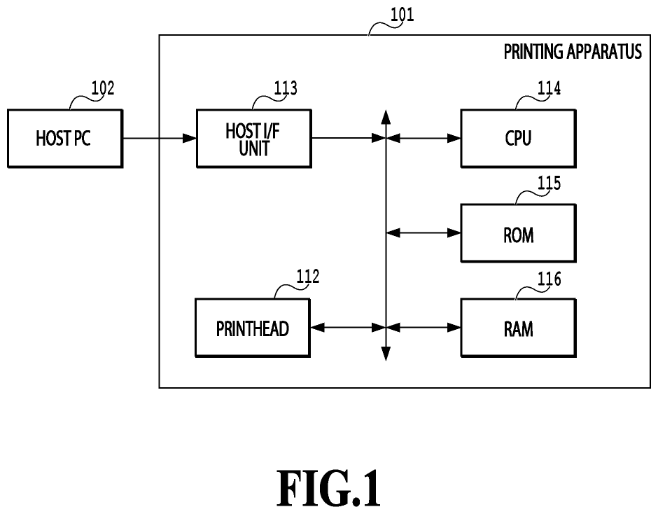

An inkjet printing apparatus (hereinafter a printing apparatus) according to the present embodiments is described with reference to FIGS. 1 to 4. FIG. 1 is a block diagram showing the hardware configuration of a printing apparatus 101 according to the present embodiments. Image data transmitted from a host PC 102 and inputted to the printing apparatus 101 is stored in a RAM 116 via a host I/F unit 113. Although a host PC is used as a transmission-end apparatus that transmits a print job to the printing apparatus 101 in the present embodiment, it is to be noted that an information processing apparatus such as a smartphone or a PDA may be used instead.

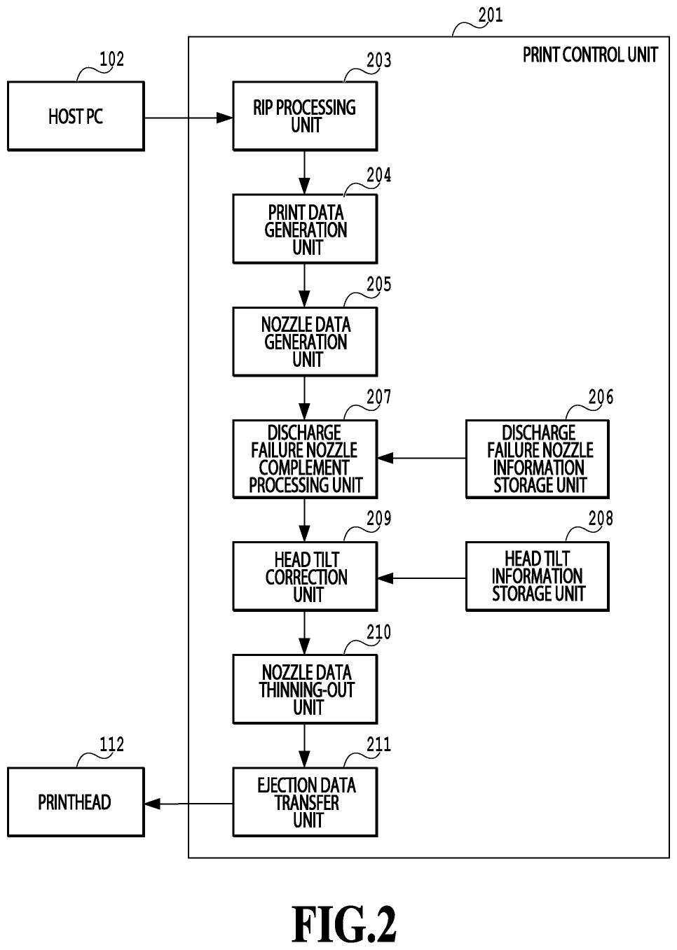

A CPU 114 controls each data processing unit (see FIG. 2) in accordance with a control program stored in a ROM 115. Specifically, the CPU 114 functions as each data processing unit and reads data necessary to function as such from the RAM 116, performs data processing on the data thus read, and writes the data back into the RAM 116.

FIG. 2 is a block diagram showing the software configuration of and data flow in a print control unit 201 of the printing apparatus 101. The data processing units forming the print control unit 201 are implemented by the CPU 114 reading a program stored in the ROM 115 and loading the read program into the RAM 116.

Image data transmitted from the host PC 102 is sent to a RIP processing unit 203. The RIP processing unit 203 performs rendering processing on this image data to obtain bitmap image data in which each pixel is in multi-value representation, and transmits the obtained image data to a print data generation unit 204.

The print data generation unit 204 executes ink color conversion processing and quantization processing on the bitmap image data in multi-value representation. Ink color conversion processing is processing to convert, for example, image data with three channels of RGB into image data with four channels of the respective ink colors (in this example, CMYK). As a result of the print data generation unit 204 executing the ink color conversion processing and the quantization processing on the bitmap image data in multi-value representation, halftone data is obtained for each ink color. The print data generation unit 204 transmits this halftone data to a nozzle data generation unit 205.

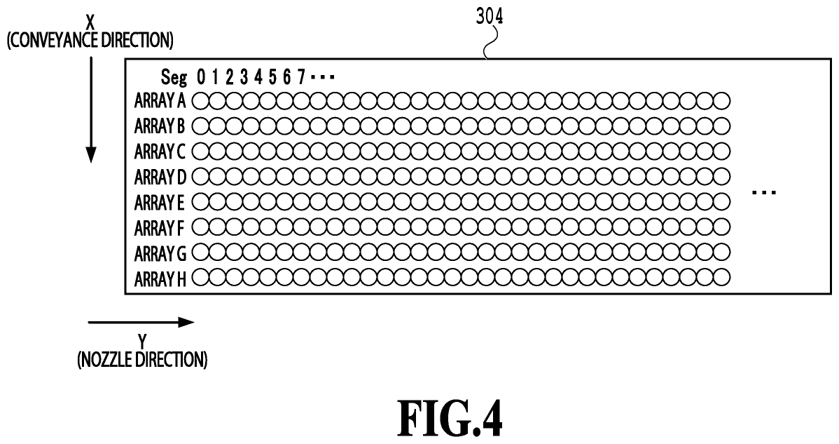

The nozzle data generation unit 205 allocates 0 or 1 to each nozzle based on the halftone data and thereby generates nozzle data. This nozzle data is sets of data on the respective nozzle arrays (also called lines) shown in FIG. 4, each set of data being data in binary representation on the nozzles included in the corresponding nozzle array, in which 0 (non-ejection) or 1 (ejection) is allocated to each nozzle.

An discharge failure nozzle complement processing unit 207 executes discharge failure nozzle complement processing on the nozzle data using discharge failure nozzle information stored in an discharge failure nozzle information storage unit 206 and transmits the nozzle data having undergone the discharge failure nozzle complement processing to a head tilt correction unit 209. The “discharge failure nozzle information” described above is information indicating a nozzle from which ink cannot be ejected (referred to as an discharge failure nozzle). Also, the “discharge failure nozzle complement processing” is processing to re-allocate ejection data allocated to an discharge failure nozzle to a nozzle from which ink can be ejected (referred to as a healthy nozzle).

The head tilt correction unit 209 executes head tilt correction processing on the nozzle data having undergone the discharge failure nozzle complement processing, using head tilt information stored in a head tilt information storage unit 208. Note that the “head tilt correction processing” is correction processing performed on data to move an ink ejection position in a printing medium conveyance direction based on the amount of tilt of a printhead 112. The conveyance direction is a direction intersecting with a direction along which nozzles are arranged to form a nozzle array (referred to as a nozzle direction). Although a mode where a printing medium is actually conveyed is shown in the present embodiments, it is to be noted that a mode where the printhead is moved without the printing medium being conveyed may be employed instead. In other words, any mode may be employed as long as a printing medium is conveyed in the conveyance direction relative to the printhead.

A nozzle data thinning-out unit 210 executes thinning-out processing on the nozzle data having undergone the head tilt correction and transmits the nozzle data having undergone the thinning-out processing to an ejection data transfer unit 211.

The ejection data transfer unit 211 transfers, to the printhead 112, the nozzle data having undergone the thinning-out processing and transmitted from the nozzle data thinning-out unit 210.

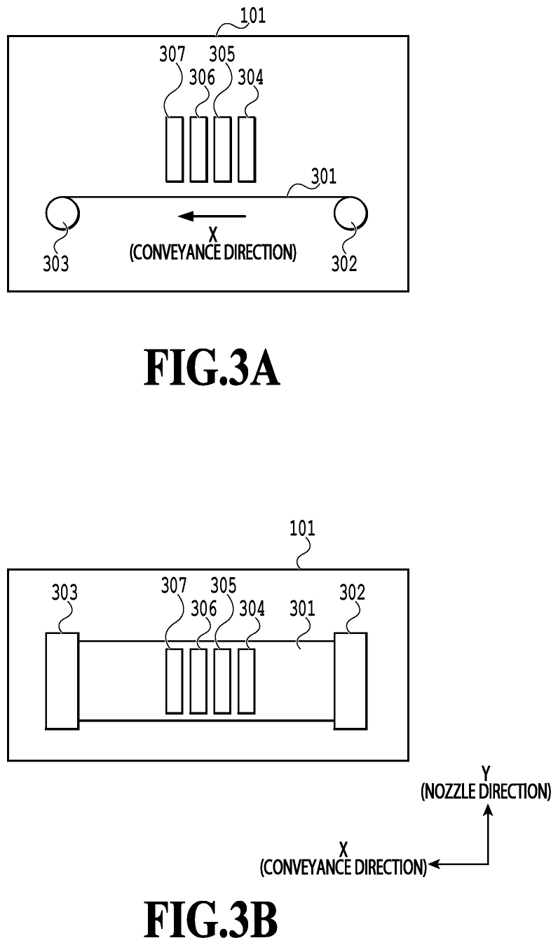

FIGS. 3A and 3B are diagrams showing a schematic configuration of the printing apparatus 101 according to the present embodiments. FIG. 3A is a view of the inside of the printing apparatus 101 seen from the side, and FIG. 3B is a view of the inside of the printing apparatus 101 seen from above. The CPU 114 executes conveyance operation using a conveyance motor, a conveyance roller, and conveyance means such as a belt forming a conveyance path 301, to convey a printing medium at a predetermined speed. A printing medium fed from a paper feed unit 302 is conveyed in the X-direction along the conveyance path 301 and is discharged from a paper discharge unit 303. Printheads 304, 305, 306, 307 are printheads that eject inks of different colors (in this example, CMYK) from one another and eject the inks to a printing medium conveyed in the X-direction along the conveyance path 301.

FIG. 4 is a diagram showing the configuration of the printhead 304, depicting its ejection port formation surface. The printhead 304 is formed by a plurality of nozzle arrays whose positions in the X-direction (the printing medium conveyance direction) are different from one another, and in the example in FIG. 4, there are eight arrays (specifically, arrays A to H). Nozzles in each nozzle array are disposed in the Y-direction (a direction perpendicular to the conveyance direction), in the number corresponding to the printing width of the printing apparatus. Note that the printheads 305, 306, 307 have the same configuration as the printhead 304. A single printhead ejects an ink of a single color, and the plurality of nozzle arrays in a single printhead all eject an ink of the same color. Note that the settings related to the coordinates in FIG. 4 (the X direction and the Y direction) are also used in other drawings.

Heat generators (e.g., heaters) are disposed facing the corresponding nozzles included in each nozzle array, and the ink is ejected by application of energy to the heat generators. Note that means for ink ejection is not limited to a heat generator, and for example, a piezoelectric element may be used.

### <Print Region and Inspection Region>

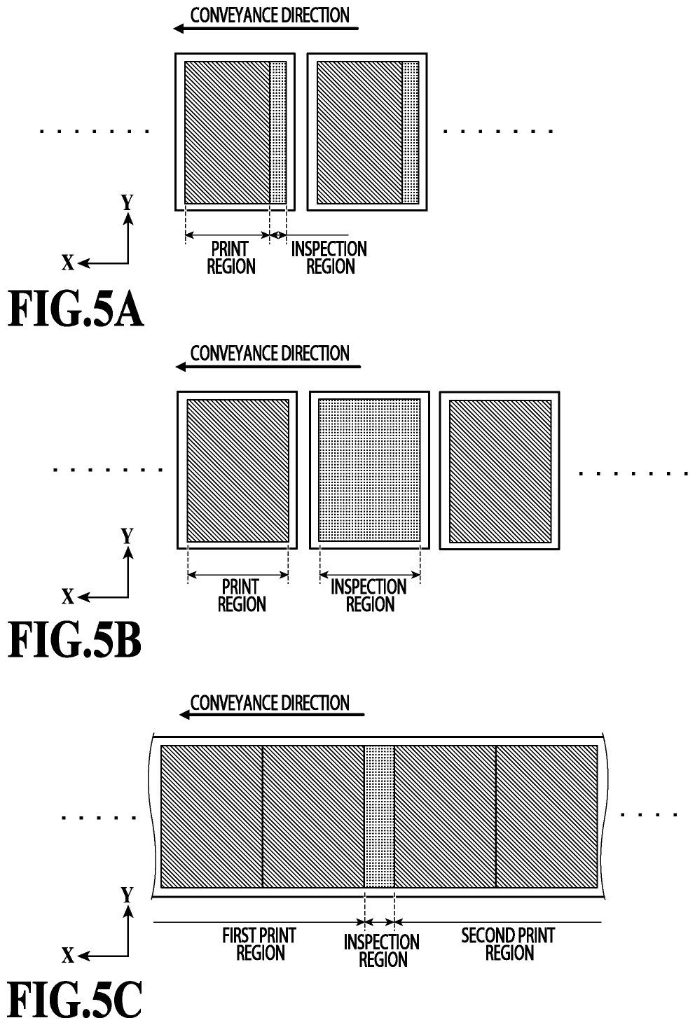

FIGS. 5A to 5C are diagrams showing a region on a printing medium where an image specified by a user is printed (referred to as a print region) and an inspection region on the printing medium where an inspection pattern is printed based on inspection data for inspecting the ejection state of the nozzles in the printhead.

FIGS. 5A and 5B show an inspection region on a cut sheet of paper. Specifically, FIG. 5A shows a case of using part of a printable region on a cut sheet of paper as an inspection region, and FIG. 5B shows a case of using the entire printable region on a single cut piece of paper as an inspection region.

By contrast, FIG. 5C shows print regions and an inspection region on a roll of paper, the inspection region being printed between a first print region and a second print region.

### First Embodiment

### <Configuration Related to Control of Print Operation and Inspection Operation>

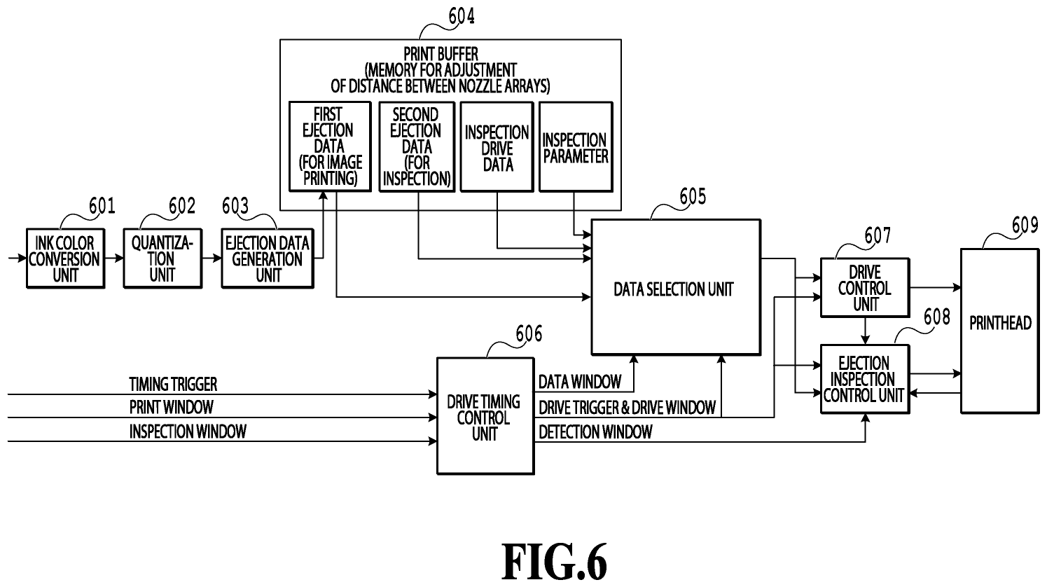

With reference to FIG. 6, the following describes how the control of the print operation and the inspection operation is performed. FIG. 6 is a block diagram showing a configuration related to control of the print operation and the inspection operation. Note that each data processing unit shown in FIG. 6 is implemented by the CPU 114 reading a program stored in the ROM 115 and loading the read program into the RAM 116.

An ink color conversion unit 601 converts image data with three channels of RGB inputted thereto into image data on each ink color, i.e., image data of four channels of CMYK. A quantization unit 602 performs quantization processing on the image data on each ink color to generate and obtain print data. An ejection data generation unit 603 allocates this print data to each nozzle. A printhead 609 ejects ink according to the data allocated to each nozzle.

Because the nozzles in the printhead are disposed in such a manner as to be displaced two-dimensionally, landing positions on a printing medium are adjusted by transmitting the nozzle data to the printhead at shifted timings. In the present embodiment, in order to transmit the nozzle data to the printhead at shifted timings, the nozzle data needs to be held in a memory with a capacity corresponding to the physical distance between at least the most upstream nozzles (nozzles in the array A) and the most downstream nozzles (nozzles in the array H) in the printing medium conveyance direction. For this reason, a print buffer 604 is provided for the purpose of creating such memory.

A data selection unit 605 transmits the nozzle data held in the print buffer 604 to a drive control unit 607 and an ejection inspection control unit 608 at shifted timings in conformity with the actual arrangement of the nozzles.

In execution of print operation to print an image that a user wants to output, the data selection unit 605 reads first ejection data from the print buffer 604 and transmits the first ejection data to the drive control unit 607. The “first ejection data” is ejection data for printing an image that a user wants to output, and has been processed by the ink color conversion unit 601, the quantization unit 602, and the ejection data generation unit 603 and is held in the print buffer 604. Note that the ejection inspection control unit 608 does not operate while the print operation is being executed. Also, what it means by driving in the present embodiment is to supply energy to elements (e.g., heat generators or piezoelectric elements) facing the nozzles to eject ink from the nozzles.

Meanwhile, in execution of inspection operation to inspect whether ink is properly ejected from the nozzles, the data selection unit 605 reads second ejection data, inspection drive data, and an inspection parameter from the print buffer 604 and transmits them to the drive control unit 607 and the ejection inspection control unit 608. The “second ejection data” is ejection data for printing an inspection pattern and is directly loaded into or held in the print buffer 604 without going through the ink color conversion unit 601, the quantization unit 602, and the ejection data generation unit 603. In performing printing using a certain (single) nozzle array, ink cannot be ejected simultaneously from all the nozzles, but the printing needs to be done with the nozzles being divided into groups. Thus, the “inspection drive data” is data indicating the order of such divided printing. The “inspection parameter” refers to, e.g., a duration of time over which heaters are on (i.e., a pulse width) as an index of the amount of energy for ejection. Upon receipt of these pieces of data, the drive control unit 607 controls the driving of the printhead using an ejection inspection driving method. Also, upon receipt of these pieces of data, the ejection inspection control unit 608 performs ejection inspection control using the second ejection data and also receives inspection result data transmitted from the printhead 609. After receiving the inspection result data, the ejection inspection control unit 608 can judge whether the nozzles of the inspection target are in a state of being capable of ejection or a state of being incapable of ejection and ultimately obtains information indicating nozzles in a state of being incapable of ejection (referred to as discharge failure nozzle information).

A drive timing control unit 606 controls the timing and ejection cycle of the actual ejection. More specifically, first, the drive timing control unit 606 receives input of a timing trigger in synchronization with conveyance of a printing medium, a print window for informing of a zone for the print operation, and an inspection window for informing of a zone for the inspection operation.

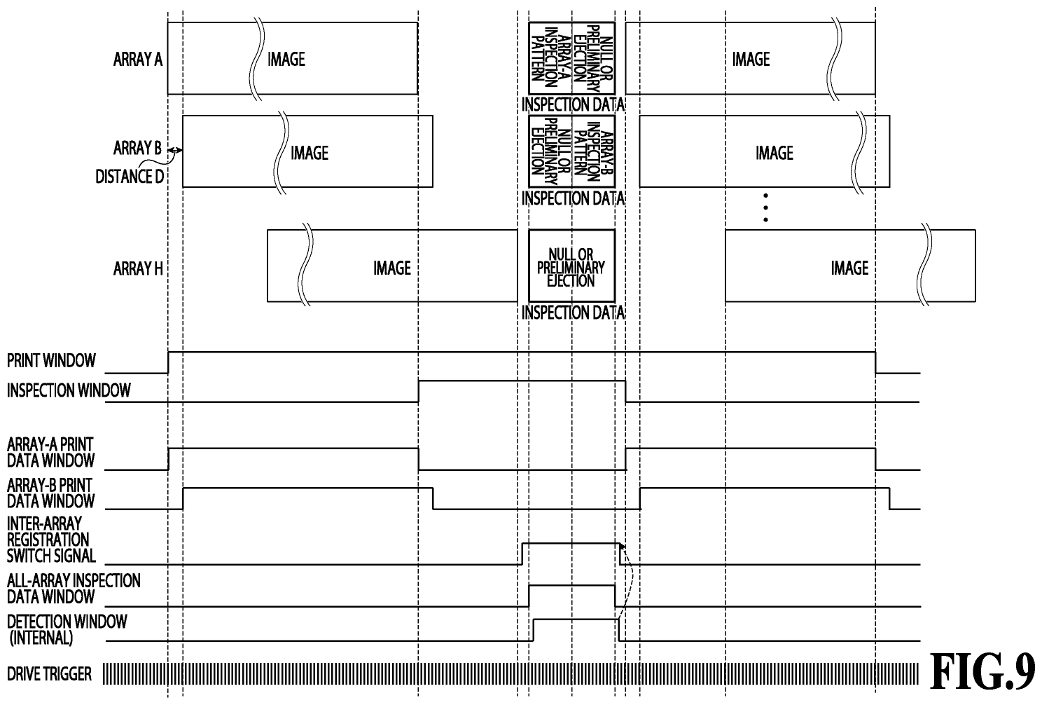

Then, based on these signals, the drive timing control unit 606 transmits a drive trigger to the data selection unit 605, the drive control unit 607, the ejection inspection control unit 608, the drive trigger being used as a reference trigger for driving. Also, the drive timing control unit 606 transmits, to the data selection unit 605, a data window for informing of timing to read and obtain data from the print buffer 604. The drive timing control unit 606 also transmits a drive window for informing of ink ejection timing to the drive control unit 607 and the ejection inspection control unit 608. Note that the “drive window” is a window for informing of timing of ink ejection, or specifically, timing to apply energy necessary for ink ejection to elements facing the nozzles (see FIG. 9). Also, the elements facing the nozzles are, for example, heat generators or piezoelectric elements.

The drive timing control unit 606 also transmits, to the ejection inspection control unit 608, a detection window for informing of detection timing of nozzle inspection.

The drive control unit 607 receives nozzle data in which the distance between nozzle arrays has been adjusted, adds driving data to the nozzle data thus received, and then transmits the resultant data to the printhead 609.

The ejection inspection control unit 608 functions only during the inspection operation, and receives nozzle data in which the distance between nozzle arrays has been adjusted, determines nozzles to be inspected as well as a driving condition for inspection and an inspection condition, and transmits them to the printhead 609. The “driving condition” here is synonymous with the inspection drive data described earlier, and the “inspection condition” is information determined based on the inspection parameter described earlier. Note that the second ejection data for nozzle inspection needs to be directly stored in the print buffer 604 without going through the quantization unit 602, because the ejection is to be performed from specified nozzles. Also, in the present embodiment, temperature sensors provided for the respective nozzles are used to detect the ejection state of nozzles to be inspected, i.e., whether the nozzles are capable of ejection. However, the means and method for the discharge failure nozzle detection are not limited to temperature sensors. For example, optical detection means may be employed, or a method of reading a dot pattern formed on a printing medium may be employed. Further, means for detecting the ejection state of the nozzles is not a configuration essential in the printing apparatus of the present embodiment, and for example, an apparatus different from the printing apparatus may be used to inspect a printing medium on which dots have been formed by the printing apparatus.

### <Detailed Configuration of the Drive Timing Control Unit 606>

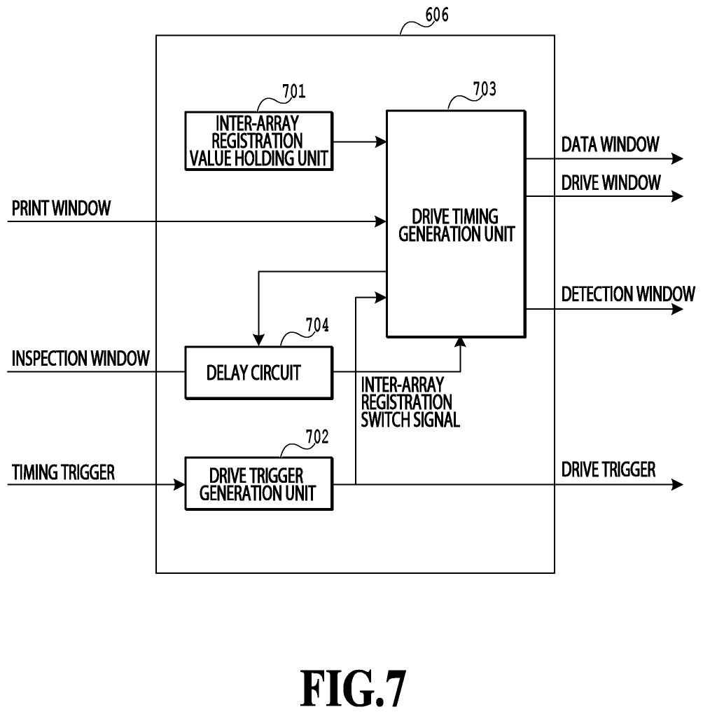

FIG. 7 is a block diagram showing a detailed configuration of the drive timing control unit 606 according to the present embodiment.

A drive trigger generation unit 702 generates a drive trigger and outputs the generated drive trigger to a drive timing generation unit 703 and to the outside of the drive timing control unit 606. As the drive trigger to generate, a fixed cycle trigger or a timing trigger in synchronization with conveyance of a printing medium is selectively used. In other words, the drive trigger generation unit 702 can switch the trigger between a fixed cycle trigger and a timing trigger depending on the purpose, and transmits either a fixed cycle trigger or a timing trigger to the drive timing generation unit 703 and outputs it to the outside of the drive timing control unit 606 as well.

An inter-array registration value holding unit 701 has inter-array registration values held therein as adjustment values in accordance with the distances between nozzle arrays. An “inter-array registration value” is a correction value (an adjustment value) for changing (adjusting) the timing of ink ejection according to the distance between nozzle arrays (displacement between nozzle arrays) (such as, for example, a period of time corresponding to the distance D in FIG. 9).

Based on the correction value (inter-array registration value) in accordance with the distance between the nozzle arrays held in the inter-array registration value holding unit 701, the drive timing generation unit 703 generates, for each nozzle array, a data window for informing of timing to obtain data from the print buffer 604. The drive timing generation unit 703 then sends the generated data window to the data selection unit 605 in FIG. 6.

The drive timing generation unit 703 also generates a drive window for each nozzle array based on the correction value (the inter-array registration value) in accordance with the distance between the nozzle arrays held in the inter-array registration value holding unit 701. The drive timing generation unit 703 then sends the generated drive window to the drive control unit 607 and the ejection inspection control unit 608 in FIG. 6.

The drive timing generation unit 703 also generates a detection window for informing of timing of ejection inspection based on information on the inspection data and the inter-array registration value for the most upstream nozzle array (which is the array Ain this example) held in the inter-array registration value holding unit 701. The drive timing generation unit 703 then transmits the generated detection window to the ejection inspection control unit 608 in FIG. 6. Note that the “information on the inspection data” mentioned above is information that the inspection data itself has and is, for example, the width of the inspection data on the array A, the width of the inspection data on the array B, or the like.

Note that creating a delay from a certain reference, which is necessary to generate various signals at shifted timings, is performed by counting the drive trigger generated by the drive trigger generation unit 702 in FIG. 7. A delay circuit 704 generates a signal in which the rising edge of an inspection window sent from the outside is delayed until an image immediately before the inspection data is printed with all the nozzle arrays (this signal is referred to as an inter-array registration switch signal) and transmits this signal to the drive timing generation unit 703. The “inter-array registration switch signal” is a signal for switching the above-described registration value between valid and invalid.

Upon receipt of the inter-array registration switch signal, the drive timing generation unit 703 invalidates the inter-array registration value obtained from the inter-array registration value holding unit 701, generates an inspection data window for each nozzle array, and sends it to the data selection unit 605 in FIG. 6. Note that the inspection data window is a window for informing of timing to obtain the second ejection data for inspection from the print buffer 604. Also, because the registration value is invalid, the inspection data windows for the respective nozzle arrays are signals with the same rising timing and falling timing.

Also, upon receipt of the inter-array registration switch signal, the drive timing generation unit 703 invalidates the registration value obtained from the inter-array registration value holding unit 701, generates an inspection drive window for each nozzle array, and sends it to the drive control unit 607 and the ejection inspection control unit 608 in FIG. 6. Note that the inspection drive window is a window for informing of timing for the printhead to eject ink during the inspection operation. Also, because the registration value is invalid, the inspection drive windows for the respective nozzle arrays are signals with the same rising timing and falling timing.

The drive timing generation unit 703 also generates a detection window for informing of timing of ejection inspection based on information on the inspection data held in the print buffer 604 and transmits the generated detection window to the ejection inspection control unit 608. Note that the “information on the inspection data” is information that the inspection data itself has and is, for example, the width of the inspection data on the array A, the width of the inspection data on the array B, or the like.

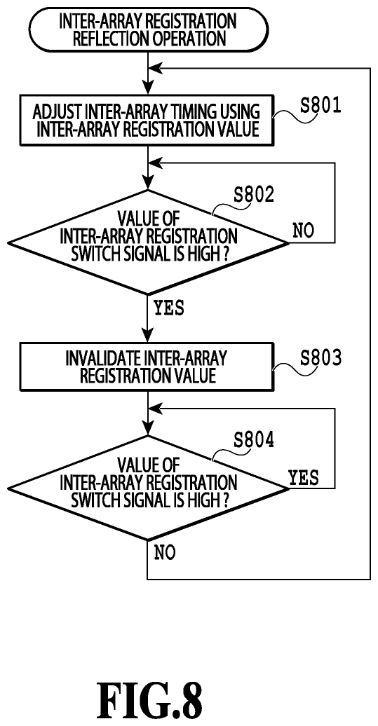

With reference to FIG. 8, inter-array registration reflection operation executed by the drive timing generation unit 703 is described. FIG. 8 is a flowchart of the inter-array registration reflection operation.

In Step S801, the drive timing generation unit 703 performs timing adjustment for the nozzle arrays using the inter-array registration value held in the inter-array registration value holding unit 701 in FIG. 7. Hereinafter, “Step SXXX” will be abbreviated as “SXXX.”

In S802, the drive timing generation unit 703 determines whether the value of the inter-array registration switch signal is HIGH. If the determination result in this step is true (i.e., the value of the inter-array registration switch signal is HIGH), the processing proceeds to S803. Meanwhile, if the determination result in this step is false (i.e., the value of the inter-array registration switch signal is still LOW), the drive timing generation unit 703 waits until the value of the inter-array registration switch signal becomes HIGH.

In S803, the drive timing generation unit 703 invalidates the inter-array registration value.

In S804, the drive timing generation unit 703 determines whether the value of the inter-array registration switch signal is HIGH. If the determination result in this step is true (i.e., the value of the inter-array registration switch signal is still HIGH), the drive timing generation unit 703 waits until the value of the inter-array registration switch signal becomes LOW. Meanwhile, if the determination result in this step is false (i.e., the value of the inter-array registration switch signal has become LOW), the processing proceeds back to S801 to perform inter-array timing adjustment using the value held in the inter-array registration value holding unit 701, in order to perform printing control of the next image.

FIG. 9 is a diagram illustrating the operation of the drive timing control unit 606 according to the present embodiment and shows the waveforms of various signals and the like. Note that FIG. 9 shows an operation where inspection to detect the health of the specified nozzles in terms of their ejection capability is performed for the arrays A to G but not for the array H, and no depiction is provided for the arrays C to G for the sake of convenience.

The signals depicted in the timing chart in FIG. 9 are each a signal inputted to or outputted from the drive timing control unit 606. Specifically, there are a drive trigger equivalent to a timing trigger in synchronization with conveyance of a printing medium, a print window informing of a zone for printing, and an inspection window informing of an inspection zone for nozzle inspection. There are also an array-A print data window indicating timing to obtain print data for the array A (the first ejection data in FIG. 6) from the print buffer 604 and an array-B print data window indicating timing to obtain print data for the array B from the print buffer 604. There are also an inter-array registration switch signal informing of whether the inter-array registration function is enabled or disabled and an inspection data window indicating the timing to obtain inspection data for each array from the print buffer 604. There is also a detection window (internal signal) for making inspection timing conform with actual nozzle ejection.

Upon receipt of input of the print window, the drive timing generation unit 703 transmits, based on the print window, a drive trigger used as a drive reference trigger and a data window informing of timing to read and obtain data from the memory, to the data selection unit 605. The drive timing generation unit 703 also transmits, based on the print window, a drive trigger used as a reference trigger and a drive window (not shown in FIG. 9) for informing of ejection timing, to the drive control unit 607. The drive timing generation unit 703 also transmits, based on the print window, a drive trigger, a drive window, and a detection window for informing of detection timing of nozzle inspection, to the ejection inspection control unit 608.

The drive control unit 607 receives nozzle data in which the distance between nozzle arrays has been adjusted, adds data for driving to the received nozzle data, and transmits the resultant data to the printhead 609.

As shown in FIG. 9, the print data window for each array (the array A, B, . . . ) is delayed by an amount of inter-array displacement held in the inter-array registration value holding unit 701 in FIG. 7 in reference to the print window and the inspection window sent from the outside, and is outputted from the drive timing control unit 606. In this event, while the inspection window is being inputted, the signal value of the print data window for each array sequentially becomes LOW. The state where the signal value is LOW is hereinafter referred to as an inactive state. FIG. 9 shows waveforms of a case where the inter-array displacement of the array A is 0 and the inter-array displacement of the array B (between the arrays A and B) is a distance D. In other words, the rising timing of the print data window for the array B is later than the rising timing of the print data window for the array A by a time corresponding to the distance D.

As shown in FIG. 9, with the rising edge of the inspection window being the start point, the delay circuit 704 in FIG. 7 creates a delay to a point past the timing when all the nozzle arrays finish ejection for an image immediately before the inspection data (i.e., the timing when the array H finishes driving). This timing is the timing when the inter-array registration switch signal value is set to HIGH. A state in which the signal value is HIGH is referred to as an active state. FIG. 9 shows that the inter-array registration switch signal is set to HIGH at the timing when the array H finishes printing an image. As shown in FIG. 9, the inter-array registration switch signal is such that the value thereof is set to LOW once the detection window (internal) is closed. Because of the inter-array registration switch signal, ink ejection based on the inspection data does not start until all the nozzle arrays complete ink ejection for an image printed by print operation immediately before inspection operation.

The inspection data window is generated by the drive timing generation unit 703 based on the inter-array registration switch signal. More specifically, the inspection data window is generated so that in a zone where the value of the inter-array registration switch signal is HIGH, the value of the signal is HIGH in a period corresponding to the size of the inspection data. Because the detection window and the drive window for each nozzle array (not shown in FIG. 9) are signals of the actual ejection timing, the signals are delayed from the inspection data window by several columns. The delaying of the various signals is performed by counting the drive triggers generated by the drive trigger generation unit 702 in FIG. 7.

The results shown in FIG. 9 show that even if the amount of displacement between the array A and the array B changes from D, the content of the inspection data is not affected by the change. Thus, according to the present embodiment, inspection data prepared before printing can be used even if the adjustment value for the inter-array distance is dynamically changed because of a change in the distance between the nozzle arrays during printing.

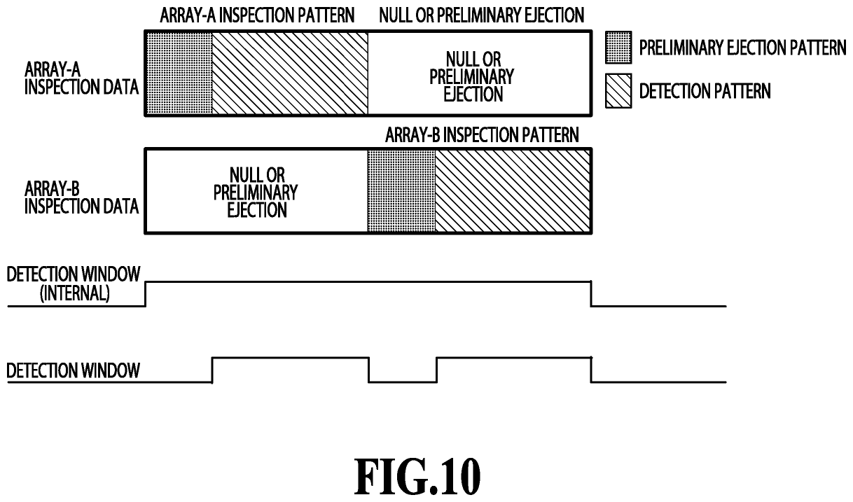

As details of a detection window generated by the drive timing control unit 606 according to the present embodiment, FIG. 10 shows an example where the array A and the array B are inspected at once. Although not shown in FIG. 10, the structures of the inspection data for the arrays C to H are the same as that for the array A or B. Specifically, the inspection data has null (or preliminary ejection) data and has data on an inspection pattern for each array in a case where inspection is necessary. An inspection pattern is formed by a preliminary ejection pattern (the dotted region in FIG. 10) and a detection pattern (the hatched region in FIG. 10).

As shown in FIG. 10, an inspection pattern included in inspection data is divided into a preliminary ejection pattern and a detection pattern. Thus, based on the detection window (internal) generated by the drive timing generation unit 703, the detection window is generated so that the signal value may be HIGH only for the detection pattern portion. Note that for the width of the preliminary ejection pattern and the width of the detection pattern, values preset in the register are used.

### Second Embodiment

A second embodiment is described below. Note that the following omits points that are the same as those in the first embodiment where appropriate and focuses on points different from the first embodiment.

### <Detailed Configuration of the Drive Timing Control Unit 606>

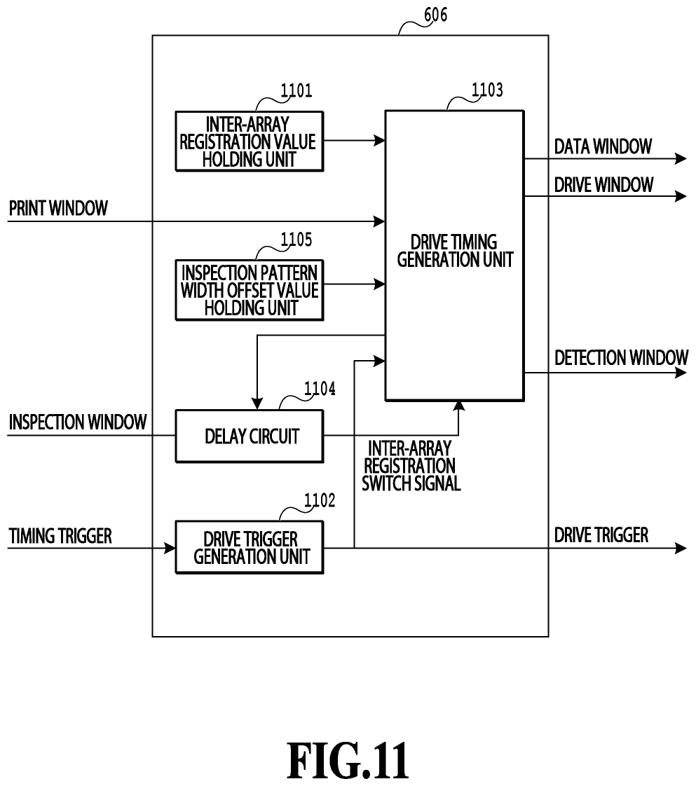

FIG. 11 is a block diagram showing a detailed configuration of the drive timing control unit 606 according to the present embodiment.

A drive trigger generation unit 1102 generates a drive trigger and outputs the generated drive trigger to a drive timing generation unit 1103 and to the outside of the drive timing control unit 606. As the drive trigger to generate, a fixed cycle trigger or a timing trigger in synchronization with conveyance of a printing medium is selectively used. In other words, the drive trigger generation unit 1102 can switch the trigger between a fixed cycle trigger and a timing trigger depending on the purpose, and transmits either a fixed cycle trigger or a timing trigger to the drive timing generation unit 1103 and also outputs it to the outside of the drive timing control unit 606.

An inter-array registration value holding unit 1101 has inter-array registration values held therein.

The drive timing generation unit 1103 generates, for each nozzle array, a data window for informing of timing to obtain data from the print buffer 604 based on the adjustment value (inter-array registration value) in accordance with the distance between the nozzle arrays held in the inter-array registration value holding unit 1101. The drive timing generation unit 1103 then sends the generated data window to the data selection unit 605 in FIG. 6.

The drive timing generation unit 1103 also generates a drive window for each nozzle array based on the adjustment value (the inter-array registration value) in accordance with the distance between the nozzle arrays held in the inter-array registration value holding unit 1101. The drive timing generation unit 1103 then sends the generated drive window to the drive control unit 607 and the ejection inspection control unit 608 in FIG. 6.

The drive timing generation unit 1103 also generates a detection window for informing of timing of ejection inspection based on information on the inspection data and the inter-array registration value of the most upstream nozzle array (which is the array Ain this example) held in the inter-array registration value holding unit 1101. The drive timing generation unit 1103 then transmits the generated detection window to the ejection inspection control unit 608 in FIG. 6.

Note that creating a delay from a certain reference, which is necessary to generate various signals at shifted timings, is performed by counting the drive trigger generated by the drive trigger generation unit 1102 in FIG. 11. A delay circuit 1104 generates a signal in which the rising edge of an inspection window sent from the outside is delayed until an image immediately before the inspection data is printed with all the nozzle arrays (the inter-array registration switch signal) and transmits this signal to the drive timing generation unit 1103.

Upon receipt of the inter-array registration switch signal, the drive timing generation unit 1103 invalidates the inter-array registration value obtained from the inter-array registration value holding unit 1101, generates an inspection data window for each nozzle array, and sends it to the data selection unit 605 in FIG. 6. The present embodiment differs from the first embodiment (see FIG. 7) in having an inspection pattern width offset value holding unit 1105 which holds an offset value for the inspection pattern width. Using the offset value for the inspection pattern width, the drive timing generation unit 1103 can generate an inspection data window in accordance with the inspection timing for each nozzle array.

Also, upon receipt of the inter-array registration switch signal, the drive timing generation unit 1103 invalidates the registration value obtained from the inter-array registration value holding unit 1101, generates an inspection drive window for each nozzle array, and sends it to the drive control unit 607 and the ejection inspection control unit 608 in FIG. 6. Note that because the registration value is invalid, the inspection drive windows for the respective nozzle arrays are the same signal.

The drive timing generation unit 1103 also generates a detection window based on the inspection data held in the print buffer 604 and transmits the generated detection window to the ejection inspection control unit 608.

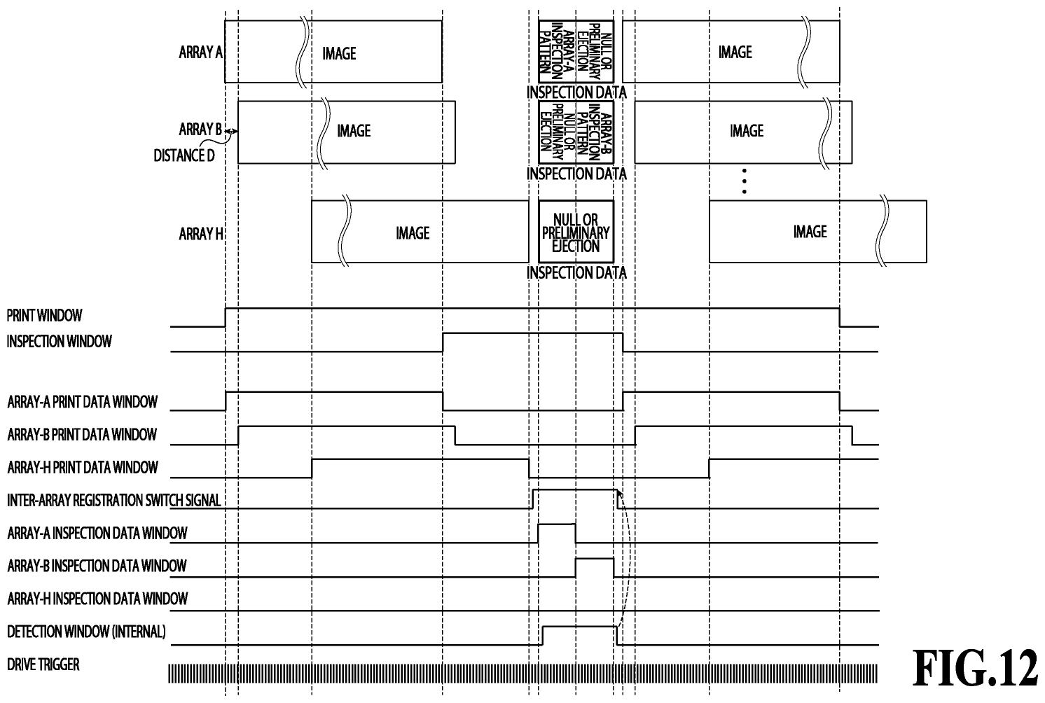

FIG. 12 is a diagram illustrating the operation of the drive timing control unit 606 according to the present embodiment and shows the waveforms of various signals and the like. The signals depicted in the timing chart in FIG. 12 are each a signal inputted to or outputted from the drive timing control unit 606. Specifically, there are a drive trigger equivalent to a timing trigger in synchronization with conveyance of a printing medium, a print window informing of a zone for printing, and an inspection window informing of an inspection zone for nozzle inspection. There are also an array-A print data window indicating timing to obtain print data for the array A (the first ejection data in FIG. 6) from the print buffer 604 and an array-B print data window indicating timing to obtain print data for the array B from the print buffer 604. There are also an inter-array registration switch signal informing of whether the inter-array registration function is enabled or disabled and an inspection data window, for each nozzle array (the array A, B, H in FIG. 12), indicating the timing to obtain inspection data for each array from the print buffer 604. There is also a detection window (internal signal) for making inspection timing to conform with actual nozzle ejection.

As shown in FIG. 12, the print data window for each array (the array A, B, . . . ) is delayed by an amount of inter-array displacement held in the inter-array registration value holding unit 1101 in FIG. 11 in reference to the print window and the inspection window sent from the outside, and is outputted from the drive timing control unit 606. In this event, while the inspection window is being inputted, the signal value of the print data window for each array sequentially becomes LOW. The state where the signal value is LOW is hereinafter referred to as an inactive state. FIG. 12 shows waveforms of a case where the inter-array displacement of the array A is 0 and the inter-array displacement of the array B is a distance D. With the rising edge of the inspection window being the start point, the delay circuit 1104 in FIG. 11 creates a delay to the timing when all the nozzle arrays finish ejection for an image immediately before the inspection data, and this timing is timing when the inter-array registration switch signal value is set to HIGH. The state in which the signal value is HIGH is referred to as an active state. FIG. 12 shows that the inter-array registration switch signal is set to HIGH at the timing when the array H finishes printing the image. As shown in FIG. 12, the inter-array registration switch signal is such that the value thereof is set to LOW once the detection window (internal) is closed.

The inspection data window for each nozzle array is generated by the drive timing generation unit 1103 based on the inter-array registration switch signal. More specifically, the inspection data window is generated so that in a zone where the value of the inter-array registration switch signal is HIGH, the value of the signal is HIGH in a period corresponding to the size of the inspection pattern included in the inspection data. Using the offset value of the inspection pattern held in the inspection pattern width offset value holding unit 1105, the drive timing generation unit 1103 generates a signal (a detection data window) which is set to HIGH when the inspection data for each array is read from the print buffer 604. In the present embodiment, as shown in FIG. 12, the signal value goes into the active state in the order of the array A and the array B. Meanwhile, the array H, which is not inspected, stays in the inactive state at all times. Because the detection window and the drive window for each nozzle array (not shown in FIG. 12) are signals of the actual ejection timing, the signals are delayed from the inspection data window by several columns. The delaying of the various signals is performed by counting the drive triggers generated by the drive trigger generation unit 1102 in FIG. 11.

The results shown in FIG. 12 show that even if the amount of displacement between the array A and the array B changes from D, the content of the inspection data is not affected by the change. Thus, according to the present embodiment, inspection data prepared before printing can be used even if the adjustment value for the inter-array distance is dynamically changed because of a change in the distance between the nozzle arrays during printing.

Also, because the inspection data window is set to be active only at the timing of the inspection pattern for each array, a common inspection pattern can be used for all the arrays.

### <Challenge in the Prior Art>

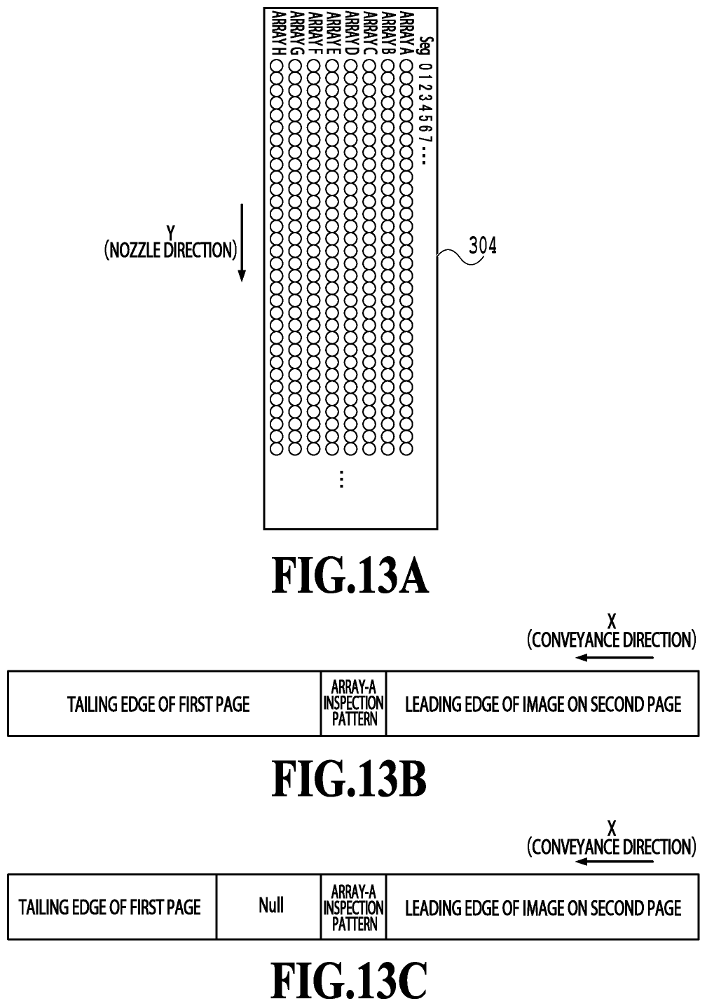

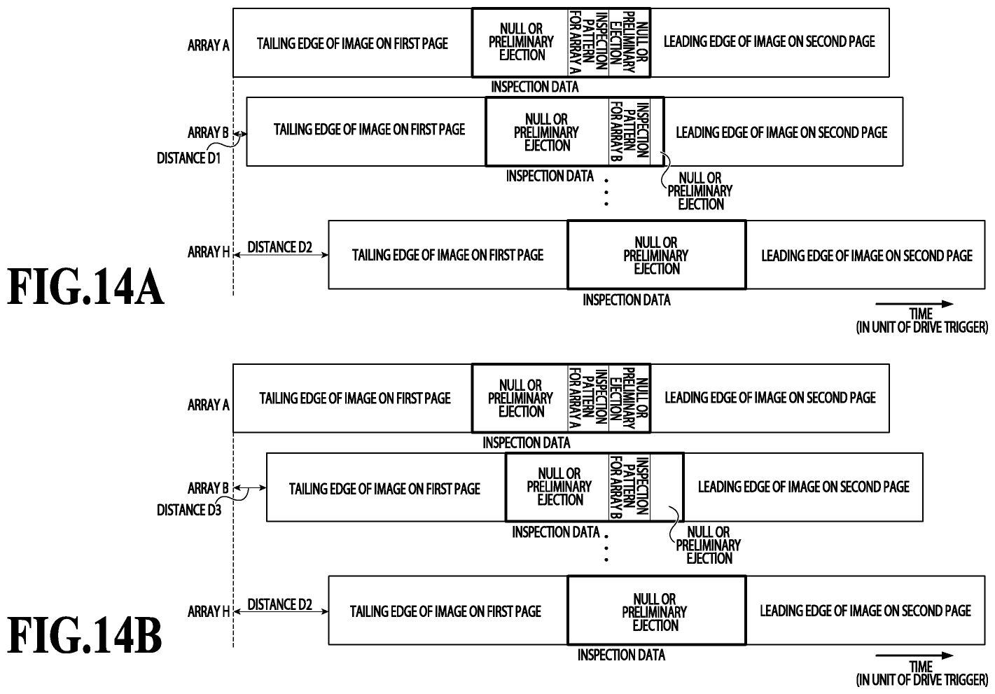

A problem in the prior art which is a challenge that the present disclosure aims to address is described with reference to FIGS. 13A to 13C, 14A, and 14B. The challenge in the prior art is, specifically, a problem that arises in a case where a printhead which does not employ the technique of the present disclosure is used to print an image based on inspection data for nozzle inspection.

FIG. 13B shows an image printed before a printhead in FIG. 13A ejects ink based on inspection data for the array A (“TAILING EDGE OF IMAGE ON FIRST PAGE” in FIG. 13B) and an image printed after the printhead in FIG. 13A ejects ink based on the inspection data for the array A (“LEADING EDGE OF IMAGE ON SECOND PAGE” in FIG. 13B). With the data structure in FIG. 13B, when ink is ejected from the nozzles of the array A based on the inspection data for the array A, the nozzles in the arrays other than the array A are in a state of ejecting ink based on the ejection data for the previous image (the tailing edge of the image on the first page), but this state is not appropriate. The reason for this is because, as described earlier, in a case of printing an inspection pattern different from page images during continuous printing of a plurality of pages, while a certain array is ejecting ink based on inspection data, arrays other than the certain array need to stop ejection. Due to this restraint, null data needs to be disposed between the trailing edge of the image on the first page and the inspection pattern for the array A as shown in FIG. 13C in order to create a state where no ejection is performed by the nozzles in the arrays other than the array A.

FIGS. 14A and 14B are each a diagram illustrating the data structure of inspection data in accordance with the physical positional displacement of nozzle arrays and show an example where nozzle inspection is performed on the arrays A and B between the image on the first page and the image on the second page.

FIG. 14A shows the data structure of inspection data for each array in a case where the array B is away from the array Aby a distance D1, and time elapses from left to right in FIG. 14A. Note that the unit of time is a count of drive triggers.

As shown in FIG. 14A, for the inspection of the array B, ejection is started based on the inspection data for the array B formed by null data (or preliminary ejection data), the inspection pattern for the array B, and null data (or preliminary ejection data), at timing delayed from the inspection data for the array A by an amount corresponding to the distance D1. This inspection data for the array B needs to be null data (or preliminary ejection data) until completion of the printing of the inspection pattern for the array A. Also, null data (or preliminary ejection data) is needed as adjustment data between completion of the printing of the inspection pattern for the array B and start of the printing of the image on the second page.

Also, FIG. 14A shows the data structure of inspection data for the array H in a case where the array H is away from the array A by a distance D2. As shown in FIG. 14A, the inspection data for the array H is prepared so that it may come at timing later than the inspection data for the array A by an amount corresponding to the distance D2 as a whole.

FIG. 14B shows the data structure of inspection data for each array in a case where the array B is away from the array A by a distance D3 (D3>D1). Note that like in FIG. 14A, time elapses from left to right, and the unit of time is a count of drive triggers.

As shown in FIG. 14B, for the inspection of the array B, ejection is started based on the inspection data for the array B formed by null data (or preliminary ejection data), the inspection pattern for the array B, and null data (or preliminary ejection data), at timing delayed from the inspection data for the array A by an amount corresponding to the distance D3. This inspection data for the array B needs to be null data (or preliminary ejection data) until completion of the printing of the inspection pattern for the array A. Also, the inspection data for the array B needs null data (or preliminary ejection data) as adjustment data between completion of the printing of the inspection pattern for the array B and start of the printing of the image on the second page.

Note that the array H is the same as that in FIG. 14A. As shown in FIGS. 14A and 14B, the data structure of the inspection data for each array varies depending on the amount of positional displacement of the array. Thus, in a case where the inter-array distance between nozzle arrays changes during printing, inspection data needs to be prepared anew.

### <Advantageous Effects Offered by the Present Disclosure>

As described above, even in a case where the inter-array registration between nozzle arrays changes dynamically due to thermal expansion of the printhead or expansion/contraction of paper, the need to create inspection data in accordance with the change and loading thereof into the memory can be eliminated by employment of the configuration and control shown in the first or second embodiment. For example, because inspection data for detecting discharge failure nozzles causes ink to be ejected from specified and selected nozzles, nozzle data, which has been converted therefrom, needs to be directly loaded into the print buffer immediately before printing, which leads to large volumes of data. For this reason, in an event where inspection data created anew as a result of a change in the inter-array registration between nozzle arrays during printing of an image is transmitted using a regular image data transmission line, a need arises to increase the band of the data transfer line.

According to the technique of the present disclosure, however, there is no need to upgrade the specifications of the transmission line because such increase in the band is unnecessary. Thus, without cost increase, a printing system can be implemented which reduces degradation of image quality by detecting discharge failure nozzles during continuous printing and complementing them with other nozzles in accordance with information on the discharge failure nozzles. The technique of the present disclosure can decrease cost increase factors such as, for example, increasing the number of lanes for high-speed communication method (such as PCIe) or upgrading the revision of a high-speed communication method.

### Other Embodiments

Although the embodiments described above are described assuming a thermal head, which ejects ink by heating, the technical concept of the present disclosure can be applied to a printhead using piezo elements. The reason for this is as follows. In a printhead using piezoelectric elements, a drive waveform generation circuit (IC) disposed to give drive waveforms to the piezoelectric elements heats up, and in a case where, e.g., the IC is disposed near the printing element board, an incident similar to that with the thermal head described above occurs.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, in a case where the inter-layer registration between nozzle arrays dynamically changes, there is no need to create new inspection data in accordance with the change and to transfer the created inspection data to a buffer. Thus, the specifications for the data transmission line in the printing apparatus does not need to be upgraded, which enables prevention of cost increase.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-082827, filed May 19, 2023, which is hereby incorporated by reference wherein in its entirety.

What is claimed is:

1. A printing apparatus comprising:
a printhead having a plurality of nozzle arrays each of which is formed by a plurality of nozzles;
a conveyance unit that conveys a printing medium relative to the printhead at a predetermined speed;
a storage unit that stores a correction value for changing timing of ink ejection in accordance with displacement between the nozzle arrays;
a switching unit that switches operation between print operation for printing an image and inspection operation for printing an image based on nozzle inspection data, without stopping conveyance operation performed by the conveyance unit; and
a first generation unit that generates, based on the correction value, a signal for ejecting ink from the printhead, wherein
the first generation unit switches the correction value from valid to invalid in synchronization with switch from the print operation to the inspection operation performed by the switching unit.

2. The printing apparatus according to claim 1, further comprising:
a second generation unit that generates ejection data for ejecting the ink to the printing medium; and
a buffer in which to store the ejection data generated by the second generation unit, the ejection data having first ejection data for the print operation and second ejection data for the inspection operation.

3. The printing apparatus according to claim 2, wherein
based on a first signal in synchronization with conveyance of the printing medium, a second signal for informing of a zone for the print operation, and a third signal for informing of a zone for the inspection operation, the first generation unit generates, using the correction value, a fourth signal for informing of timing to obtain data for each nozzle array, a fifth signal for informing of ink ejection timing, and a sixth signal for informing of timing of detection for nozzle inspection,
the first generation unit receives input of a switch signal for switching the correction value between valid and invalid, and
the switch signal is generated based on the third signal.

4. The printing apparatus according to claim 3, further comprising a selection unit that selects ejection data to use by selectively reading, in accordance with the fourth signal, either one of the first ejection data and the second ejection data that are stored in the buffer, from the buffer.

5. The printing apparatus according to claim 4, further comprising:
a drive control unit that drives the printhead in accordance with the fifth signal; and
an inspection control unit that carries out the nozzle inspection in accordance with the sixth signal.

6. The printing apparatus according to claim 5, wherein
based on inspection result data, the inspection control unit obtains discharge failure nozzle information indicating a nozzle in a state of being incapable of ejection.

7. The printing apparatus according to claim 6, further comprising an execution unit that executes discharge failure nozzle complement processing using the discharge failure nozzle information to generate ejection data for ejecting ink from a different nozzle in a state of capable of ejection instead of the nozzle in the state of being incapable of ejection.

8. The printing apparatus according to claim 1, wherein
in the printhead, the plurality of nozzle arrays are disposed in a first direction,
the plurality of nozzles in each of the plurality of nozzle arrays are disposed in a second direction intersecting with the first direction, and
the conveyance unit conveys the printing medium relative to the printhead in the first direction.

9. The printing apparatus according to claim 1, wherein
the printhead has a sensor for detecting a state of ink ejection from the nozzles.

10. The printing apparatus according to claim 3, wherein
the first generation unit further has a delay circuit that generates the switch signal, and
the switch signal causes ink ejection based on the inspection data not to be started until all the nozzle arrays complete ink ejection for printing an image in the print operation immediately before the inspection operation.

11. The printing apparatus according to claim 2, wherein
an image printed using the second ejection data based on the inspection data is disposed between a first image and a second image printed using the first ejection data.

12. The printing apparatus according to claim 3, wherein
an image in an inspection region printed based on inspection data corresponding to each of the plurality of nozzle arrays includes at least an image based on preliminary ejection data or null data,
there is a case where the image in the inspection region includes an inspection pattern for each nozzle array, and
the first generation unit generates the fourth signal, the fifth signal, and the sixth signal using an offset value which is in accordance with a width of the inspection pattern.

13. A control method for a printing apparatus having
a printhead having a plurality of nozzle arrays each of which is formed by a plurality of nozzles,
a conveyance unit that conveys a printing medium relative to the printhead at a predetermined speed,
a storage unit that stores a correction value for changing timing of ink ejection in accordance with displacement between the nozzle arrays;
a switching unit that switches operation between print operation for printing an image and inspection operation for printing an image based on nozzle inspection data, without stopping conveyance operation performed by the conveyance unit, and
a generation unit that generates, based on the correction value, a signal for ejecting ink from the printhead,
the control method comprising switching, by the first generation unit, the correction value from valid to invalid in synchronization with switch from the print operation to the inspection operation performed by the switching unit.

14. A non-transitory computer readable storage medium storing a program that causes a computer to execute a control method for a printing apparatus having
a printhead having a plurality of nozzle arrays each of which is formed by a plurality of nozzles,
a conveyance unit that conveys a printing medium relative to the printhead at a predetermined speed,
a storage unit that stores a correction value for changing timing of ink ejection in accordance with displacement between the nozzle arrays;
a switching unit that switches operation between print operation for printing an image and inspection operation for printing an image based on nozzle inspection data, without stopping conveyance operation performed by the conveyance unit, and
a generation unit that generates, based on the correction value, a signal for ejecting ink from the printhead,
the control method comprising switching, by the first generation unit, the correction value from valid to invalid in synchronization with switch from the print operation to the inspection operation performed by the switching unit.
